(19) United States
(12) Patent Application Publication
(10) Pub. No.: US 2025/0313168 A1
(43) Pub. Date: Oct. 9, 2025

(54) ENERGY-ABSORBING DEVICE

(71) Applicant: Valeo Systemes Thermiques, Le Mesnil-Saint Denis (FR)

(72) Inventors: Enzo Mitidieri, Le Mesnil-Saint Denis (FR); Sergio Da Costa Pito, Le Mesnil-Saint Denis (FR)

(73) Assignee: Valeo Systemes Thermiques, Le Mesnil-Saint Denis (FR)

(21) Appl. No.: 18/571,037

(22) PCT Filed: Jun. 3, 2022
(86) PCT No.: PCT/EP2022/065153

§ 371 Date: May 28, 2024

(30) Foreign Application Priority Data
Jun. 16, 2021 (FR) FR2106372

(51) Int. Cl. B60R 19/18; B60R 19/14; B60R 19/24

(52) U.S. Cl. CPC B60R 19/18; B60R 19/14; B60R 19/24; B60R 2019/1846; B60R 2019/1853

(57) ABSTRACT

An energy-absorbing device for a vehicle is disclosed. The energy-absorbing device includes a main direction of elongation, an external face intended to receive an impact, a core made of an energy-absorbing material, and a plastic structure that forms a one-piece entity with the core. The core is of a corrugated shape with a succession of crests in a direction of extension parallel to the main direction of elongation. The plastic structure includes means of attaching the energy-absorbing device to an element of a vehicle which is to be protected. The external face is formed at least in part by crests of the corrugated shape of the core.

The present invention relates to the field of energy-absorbing devices with which vehicles, notably motor vehicles, are equipped. More particularly, the invention relates to an energy-absorbing device arranged on a vehicle, notably motor vehicle, element that is to be protected, the element that is to be protected being, for example, a body of the vehicle or an electric battery of the vehicle.

Energy-absorbing devices of motor vehicles are usually installed between a bumper and a side member of said vehicle. Whether they are positioned at the front bumper or the rear bumper of the motor vehicle, the energy-absorbing devices have the function of at least partially absorbing the energy transferred to the vehicle during potential impacts with external elements.

More particularly, the energy-absorbing devices make it possible to prevent this energy from being transmitted entirely to the side members of the vehicle and thus make it possible to limit the deformation of said members during these impacts, it being understood that the replacement of a side member, an important structural element of the underbody of the vehicle, would require costly operations.

In order to achieve the desired impact-absorbing performance, it is known practice to make energy-absorbing devices from a suitable metal with which an additional absorber made of expanded polystyrene or any other similar material can be combined.

These energy-absorbing devices have the disadvantage of being heavy and bulky. Furthermore, because of the dimensions that these devices need in order to achieve the sought-after performance, it is difficult to make these devices compatible with the overall style and size of the vehicle. Moreover, the internal structure of these energy-absorbing devices is substantially identical at all points, and this limits or even prevents the possibility of adapting the structure to suit the given shape and location, and of significantly improving the energy-absorbing capacity of these energy-absorbing devices.

The object of the invention is therefore to alleviate at least one of the above-mentioned disadvantages by proposing a novel energy-absorbing device of which the structure and composition make it possible to absorb force in the event of impact in order to avoid force being transmitted to the vehicle elements that are to be protected, while at the same time allowing easy integration into the vehicle and a modifiable internal structure.

The invention proposes a vehicle energy-absorbing device having a main direction of elongation and an external face intended to receive at least one impact. The energy-absorbing device comprising at least a core made of at least one energy-absorbing material, the core having a corrugated shape with a succession of crests in a direction of extension parallel to the main direction of elongation, and at least one plastic structure forming a one-piece entity with the core and comprising means of attachment of the energy-absorbing device to an element of the vehicle which is to be protected.

The energy-absorbing device is intended to protect an element of the vehicle from impacts caused by one or more objects external to the vehicle. The absorbing device is such that it runs in a main direction of elongation. The absorbing device also has an exterior face intended to receive an impact.

The energy-absorbing device has the particular feature of comprising at least a core and at least one plastic structure that forms a one-piece structure with the core. Here, and throughout the following text, the term “one-piece” should be understood to mean that the plastic structure and the core form a single entity that cannot be separated without causing damage to at least one of either the plastic structure and/or the core. In other words, the plastic structure cannot be detached from the core without one or the other being damaged.

The core is made from an energy-absorbing material so as to prevent energy released following one or more impact from spreading, thus safeguarding the element that is to be protected. Furthermore, the core has a corrugated shape, the corrugated shape being a succession of at least one peak and at least one trough which are also referred to as crests. The corrugated shape preferably comprises a plurality of peaks and troughs. The crests succeed one another in a direction of extension that is parallel to the main direction of elongation of the energy-absorbing device. This arrangement of the corrugated shape of the core with respect to the energy-absorbing device as a whole allows the energy-absorbing capacity of the core, and therefore of the energy-absorbing device according to the invention, to be improved still further.

According to one embodiment, the succession of crests extends at least in part over a length of the energy-absorbing device in the main direction of elongation. As a preference, the succession of crests extends over the entire length of the energy-absorbing device in the main direction of elongation. The length of the energy-absorbing device is the distance between two longitudinal ends of the device, measured in the main direction of elongation.

According to one embodiment, the external face is formed at least in part by the crests, preferably a majority of the crests, of the corrugated shape of the core. Thus, some of the crests contribute to defining a plane which corresponds to the external face. As a result, some of the crests are arranged in such a way as to receive the energy resulting from one or more impact.

This configuration is particularly advantageous because it makes it possible to increase progressively, without creating force spikes, the reaction force applied to the object colliding with the energy-absorbing device. In addition, the energy-absorbing device is able to absorb a greater amount of energy for the same level of deformation. Thus, the invention makes it possible to obtain an energy-absorbing device that is more efficient while at the same time being lower in weight, for the same result obtained.

According to one embodiment, the external face is formed at least in part by a segment of the corrugated shape of the core. A segment of the corrugated shape corresponds to a section of this corrugated shape in a transverse and vertical plane of section containing the direction of extension of the crests and forming a sinusoid inside which the successive crests fall. In other words, the corrugated shape is made up of a multitude of segments stacked longitudinally on one another, and a segment positioned at the longitudinal end of this stack contributes to at least partially defining the external face. In this context, an upper face of the absorption device is defined by at least some of the crests of the corrugated shape, the upper face being a face connecting the external face to an internal face that is opposite to the external face, the internal face being the face that faces the element that is to be protected.

It should be noted that, in this embodiment, the external face is formed at least in part by longitudinal end edges of the corrugated shape, forming sharp edges, these sharp edges being embedded in the plastic structure. The plastics material used may notably have a lower stiffness, for example of below 2 GPa, and may be ductile, with an elongation at break in excess of 20%, so that the plastics material is able to deform, under a measured load, without revealing these sharp edges.

According to one embodiment, the crests of the corrugated shape have a radius of curvature that varies in the direction of extension of the succession of crests. The radius of curvature of a crest corresponds to the radius of a circle inside which the crest can be inscribed, the circle being viewed in a plane containing the direction of extension of the succession of crests. The crests may thus have rounded shapes that differ according to their location within the energy-absorbing device, improving their effectiveness in the event of impact.

According to one embodiment, the crests of the corrugated shape have a radius of curvature which is substantially constant in the direction of extension of the succession of crests. Here, and throughout the following text, the term “substantially” should be understood to mean within manufacturing tolerances, and any assembly tolerances there might be. In other words, the crests all have the same radius of curvature in the direction of extension of the succession of crests.

According to one embodiment, the radius of curvature of the crests of the corrugated shape, which is dependent on the material used and the thickness thereof, may have an inside radius of the order of at least 5 millimeters.

According to one embodiment, the corrugated shape has an amplitude that varies in the direction of extension of the succession of crests. The amplitude is the distance between the projection of two successive crests onto a plane perpendicular to the direction of extension of the succession of crests. Thus, in a first part of the corrugated shape, the amplitude has a first value and in a second part of the corrugated shape, the amplitude has a second value different than the first value. This feature contributes to adapting the structure of the core to the overall shape of the energy-absorbing device while at the same time adequately maintaining the energy-absorbing properties of the core.

According to one embodiment, the corrugated shape has an amplitude that is substantially constant in the direction of extension of the succession of crests.

By way of nonlimiting example, the amplitude of the corrugated shape may notably be comprised between 5 mm and 50 mm.

According to one embodiment, the corrugated shape has a pitch that varies in the direction of extension of the succession of crests. The pitch is the distance between two consecutive pattern units of the corrugated shape, measured in the direction of extension of the succession of crests. A pattern unit comprises two adjacent crests. It is thus possible to have zones in the core that each have a different pitch, making it possible for the properties of the corrugated shapes to be adapted according to the position of the zones within the core of the energy-absorbing device.

According to one embodiment, the corrugated shape has a pitch that is substantially constant in the direction of extension of the succession of crests.

By way of nonlimiting example, the pitch of the corrugated shape may notably be comprised between 50 mm and 200 mm.

The width of the energy-absorbing device is the distance between the external face of the energy-absorbing device and an internal face of the energy-absorbing device that is opposite to the external face and that is measured in a direction perpendicular to the direction of extension, perpendicular to the internal face and perpendicular to the external face.

The height of the energy-absorbing device is the distance between an upper face of the energy-absorbing device and a lower face of the energy-absorbing device that is opposite to the upper face and that is measured in a direction perpendicular to the direction of extension, perpendicular to the upper face and perpendicular to the lower face. The upper face and the lower face connect the external face to the internal face. In this context, it will be appreciated that, as the case may be, the height of the energy-absorbing device or the width of the energy-absorbing device is substantially equal to the pitch of the corrugated shape.

According to one embodiment, the corrugated shape has a variable shape varying along the direction of elongation of the energy-absorbing device and having at least a first part and a second part, the first part of the corrugated shape having a configuration different than a configuration of the second part of the corrugated shape. It should be noted that the distinct parts of the corrugated shape may notably have different configurations insofar as the value of the pitch, the value of the amplitude and/or the value of the radius of curvature differ from one part to another. It is thus possible to vary the internal structure of the energy-absorbing device by modifying the pitch within the corrugated shape, the amplitude within the corrugated shape and/or the radius of curvature of the crests within the corrugated shape so as to create several zones in the corrugated zone which are adapted to suit the technical and esthetic characteristics desired for the energy-absorbing device. The energy-absorbing device can thus be modified and adapted at will, and it should be noted that it is notably the structure of the energy-absorbing device, with its core and its plastic structure forming a one-piece entity, that allows this adaptability.

According to one embodiment, the energy-absorbing device comprises an internal face, opposite to the external face, the attachment means projecting from the internal face and comprising a connection interface that extends in a main plane of elongation of the internal face. It will be appreciated that the internal face is intended to face the element that is to be protected, in contrast to the external face which is opposite to the internal face and is intended to at least partly absorb the energy transferred to the vehicle upon potential impacts with external bodies.

According to one embodiment, the attachment means are integrated into a volume defined by faces of the plastic structure, the attachment means comprising barrels formed in the plastic structure.

According to one feature of the invention, the attachment means may be arranged in such a way that the energy-absorbing device is attached in a plane substantially coincident with the plane defined by the internal face of the energy-absorbing device. The footprint, which is to say the longitudinal dimension of the vehicle on which such an energy-absorbing device is mounted, is therefore considerably reduced since there is no energy absorber to be interposed between the structure of the vehicle and the transverse unit that forms the energy-absorbing device. In this context, provision may be made for at least the internal face of the energy-absorbing device to have a curvature that allows the energy-absorbing device to press intimately against the structure of the vehicle by adapting to the curvature of this vehicle.

According to one embodiment of the invention, the energy-absorbing device comprises a central energy-absorbing zone arranged between two attachment zones, these respectively being defined for example by a mounting plate forming an attachment interface, the dimension in the main direction of elongation of the central absorbing zone being at least a factor of two greater than the corresponding dimension of an attachment zone. In that way, what is created is a one-piece entity that absorbs force uniformly, the absorption being uniformly distributed over the attachment zones, over a large transverse dimension.

According to one embodiment, the attachment means are formed integrally with the plastic structure. Here, and throughout the following text, the term “formed integrally” should be understood to mean that the elements that are formed integrally form a single component and are therefore made of the same material or materials. This component can be obtained for example by molding or by injection molding. This component therefore differs from elements that are joined together by welding or bonding. These integrally-formed elements thus cannot be separated without destroying one and/or the other of these elements.

According to one embodiment, the energy-absorbing material may notably consist of a mixture of continuous fibers, including glass fibers, carbon fibers or any synthetic or natural fibers, and thermoplastic or thermosetting resins.

According to one embodiment, the energy-absorbing material is different than the plastic framework. The plastic framework may, by way of example, consist of a thermoplastic or thermosetting material that either is not reinforced or is reinforced with discontinuous fibers.

The invention also relates to a vehicle, notably a motor vehicle, comprising at least one element to be protected from impact and at least one energy-absorbing device having at least one of the above features, the energy-absorbing device being attached to the element that is to be protected using the attachment means such that the external face is on the opposite side from the element that is to be protected, and an internal face of the energy-absorbing device, opposite to the external face, faces the element that is to be protected.

According to one embodiment, the element that is to be protected is a body of the vehicle and/or an electric battery of the vehicle.

According to one embodiment, the energy-absorbing device is arranged on an underbody structure of the vehicle body.

According to one embodiment, the energy-absorbing device is arranged on a wall of the electric battery of the vehicle.

Further features and advantages of the invention will become more apparent from the following description, and also from a plurality of exemplary embodiments that are given by way of nonlimiting indication with reference to the appended schematic drawings, in which:

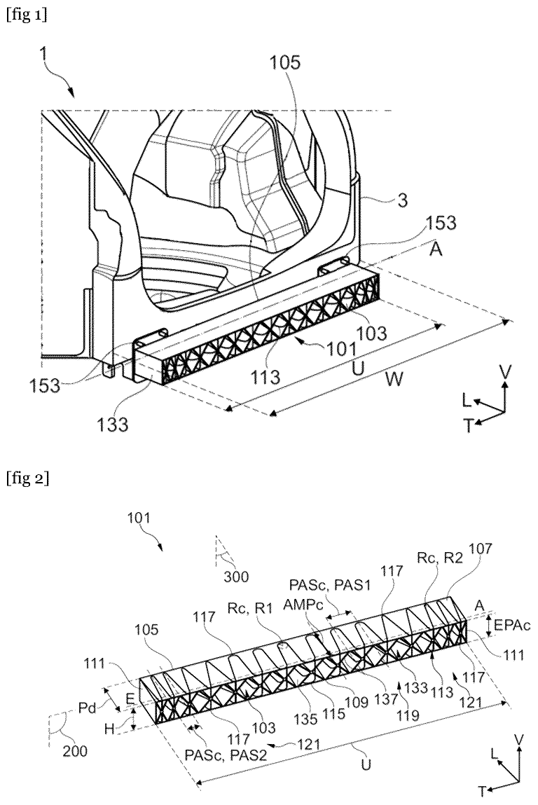

FIG. 1 is a schematic depiction of the rear of a vehicle body equipped with an energy-absorbing device according to a first embodiment of the invention;

IG. 2 is a close-up view of the energy-absorbing device of FIG. 1;

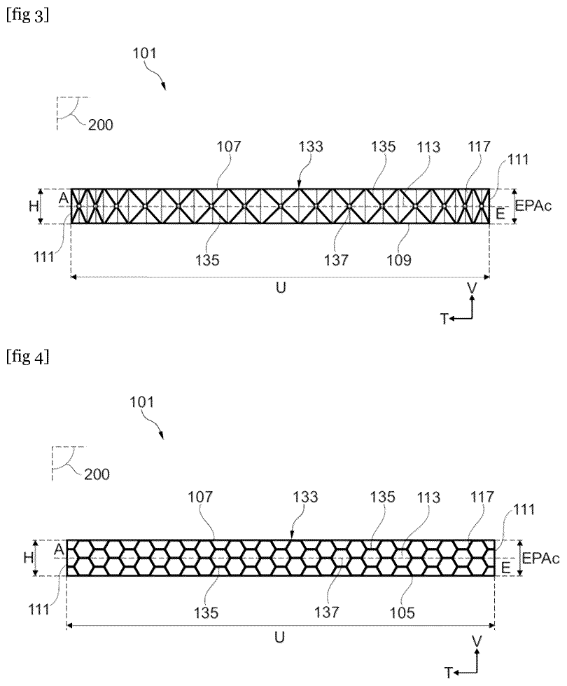

FIG. 3 is a schematic depiction of a pattern formed within a plastic structure of the absorbing device according to the first embodiment;

FIG. 4 is a schematic depiction of a pattern formed within the plastic structure in an alternative embodiment to the first embodiment of FIG. 3;

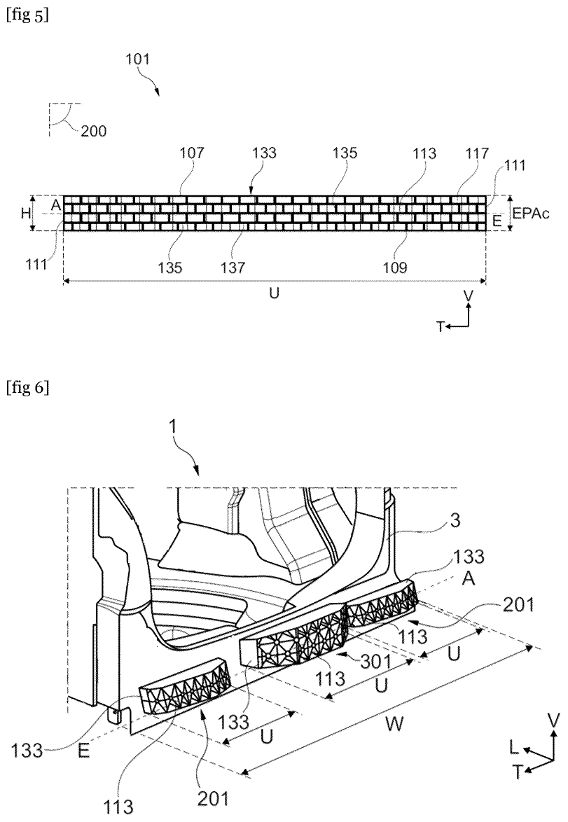

FIG. 5 is a schematic depiction of a pattern formed within the plastic structure in an alternative embodiment to the embodiments illustrated in FIG. 3 and in FIG. 4;

FIG. 6 is a schematic depiction of a vehicle body equipped with a plurality of energy-absorbing devices, one of the energy-absorbing devices according to a third embodiment being interposed between two energy-absorbing devices according to a second embodiment of the invention;

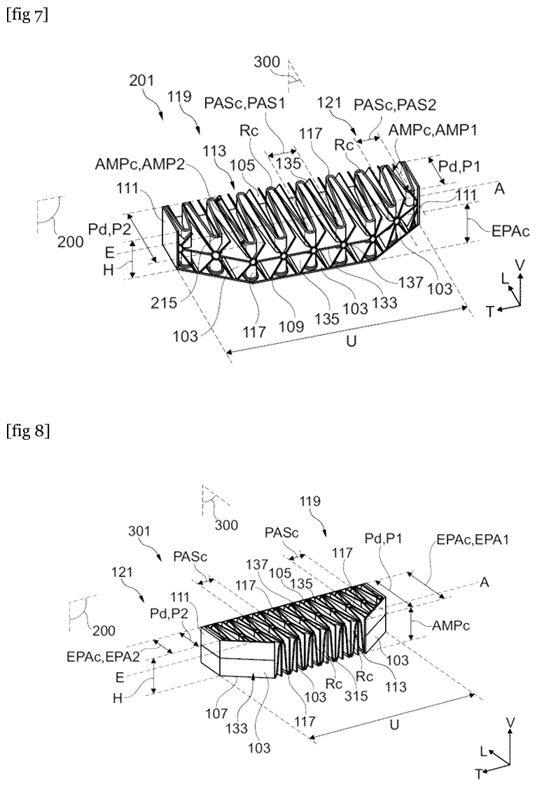

FIG. 7 is a close-up view of the energy-absorbing device according to the second embodiment of FIG. 6;

FIG. 8 is a close-up view of the energy-absorbing device according to the third embodiment of FIG. 6;

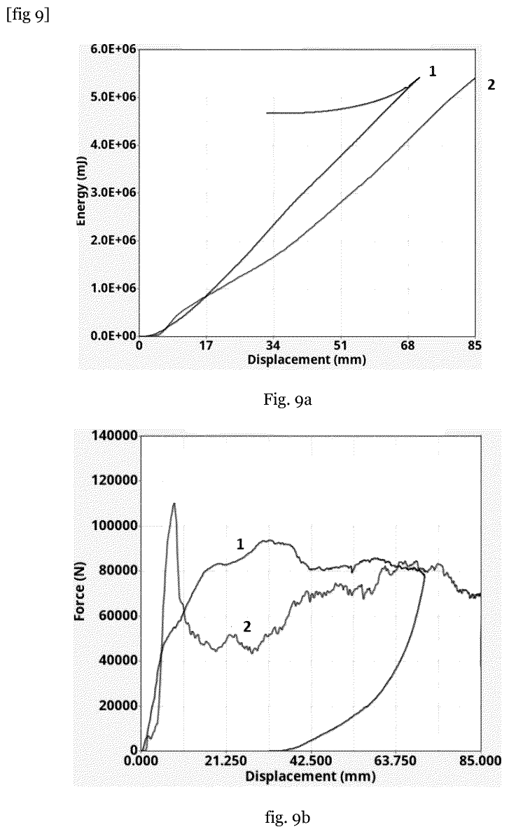

FIG. 9 is a set of FIGS. 9a and 9b illustrating the energy absorbed and the reaction force during the course of an impact, for two different energy-absorbing devices.

It should first of all be noted that although the figures set out the invention in detail for its implementation, they may, of course, be used to better define the invention if necessary. It should also be noted that, in all of the figures, elements that are similar and/or perform the same function are indicated by the same numbering.

In the description that is to follow, the longitudinal, transverse and vertical directions are defined as a function of an L, V, T trihedron illustrated in the figures. The direction in which a vehicle, notably a motor vehicle, travels in a straight line is defined as being a longitudinal direction L. By convention, the direction perpendicular to the longitudinal direction, situated in a plane parallel to the ground, is referred to as transverse direction T. A third direction, perpendicular to the other two, is referred to as vertical direction V. The forward direction corresponds to the direction in which the vehicle usually travels in the longitudinal direction L and is opposite to the rear direction.

A motor vehicle 1 depicted in FIG. 1 comprises a body 3 and at least one energy-absorbing device 101, in this instance depicted according to a first embodiment of the invention, which is arranged on a portion of the body 3. The energy-absorbing device 101 extends in a main direction of elongation A parallel to the transverse direction T of the vehicle 1, as defined hereinabove. In this first embodiment, the energy-absorbing device 101 extends over the entire transverse length W of the vehicle 1, the transverse length W being measured in the transverse direction T between a first transverse end and a second transverse end of the vehicle 1.

The energy-absorbing device 101 illustrated in FIG. 1 is intended to form part of a rear bumper of the vehicle 1 to at least partially dissipate the energy generated by a collision between the vehicle and an object so as to protect the victims and/or the body of the vehicle and/or the objects. The victims of the collision may for example be the users of the motorcar or else a pedestrian.

More generally, the energy-absorbing device according to the invention may be incorporated into any bodywork element of the vehicle such as, for example, a front or side bumper. The energy-absorbing device according to the invention may also be integrated into a protective device with which a vehicle is equipped in order to protect one or more particular elements of the vehicle, such as the electric battery.

The energy-absorbing device 101 comprises at least an external face 103 which is intended to at least partly absorb the energy transferred to the vehicle in a collision, and at least an internal face 105 opposite to the external face 103 and in this instance facing toward the center of the vehicle, by facing a rear portion of the body 3 of the vehicle 1. More generally, irrespective of the application to which the energy-absorbing device is put, the internal face 105 is intended to at least partially face the element that is to be protected when the energy-absorbing device 101 is attached to the vehicle 1.

With reference to FIG. 1, notably when the energy-absorbing device is the arranged to form a front or rear bumper, the external face 103 and the internal face 105 each extend in a plane perpendicular to the longitudinal axis L of the vehicle 1 as defined hereinabove.

As is more clearly visible in FIG. 2, the external face 103 and the internal face 105 are connected to one another by an upper face 107 and a lower face 109 opposite to the upper face 107, and by two lateral faces 111. The upper face 107 and the lower face 109 each extend in a plane perpendicular to the vertical axis V of the vehicle 1. The lateral faces 111 each extend in a plane perpendicular to the transverse axis T of the vehicle 1. Thus, it will be appreciated that, in this first embodiment, the energy-absorbing device 101 has the shape of a rectangular parallelepiped.

Thus, a length U of the energy-absorbing device 101 can be defined as being the distance between two transverse ends of the energy-absorbing device 101, which here correspond to the lateral faces 111, measured in the main direction of elongation A.

A width Pd of the energy-absorbing device 101 can also be defined as being the distance between the external face 103 and the internal face 105 of the energy-absorbing device 101, measured in the longitudinal direction L, perpendicular to the direction of elongation A, perpendicular to the internal face 105 and perpendicular to the external face 103.

A height H of the energy-absorbing device 101 can also be defined as being the distance between two vertical ends of the energy-absorbing device 101, which correspond to the upper face 107 and to the lower face 109 of the energy-absorbing device 101, measured in a vertical direction V, perpendicular to the direction of elongation A and perpendicular to the upper face 107 and to the lower face 109.

All of the length, width and height dimensions may be determined according to the volume allocated in the vehicle to the energy-absorbing device, and/or according to the defined impact zones and the desired level of absorption. It is notable according to the invention that the presence of a core of corrugated shape and of a plastic structure forming a one-piece structure with the core allows the shape or the dimensions to be adapted easily, according to what is feasible in terms of space, in order to meet the required specifications.

The energy-absorbing device 101 comprises attachment means 153 for securing it to the body 3 of the vehicle 1. The attachment means 153 depicted in FIG. 1 extend from the internal face 105 which faces the element that is to be protected. The attachment means 153 comprise a connection interface able to collaborate with retaining means, not visible in FIG. 1, belonging to the body 3 of the vehicle 1. As illustrated, the connection interface projects, notably vertically, from the parallelepiped that forms the energy-absorbing device.

The connection interface extends in a plane parallel to a main plane of elongation 200 of the internal face 105. When the energy-absorbing device 101 is mounted on the body 3 of the vehicle, the connection interface comes into direct contact with a receiving surface of the vehicle 1. This configuration is particularly advantageous because it makes it possible to dispense with the shock-absorbing blocks usually interposed between the body of the vehicle and, in particular, the side rail members, and the parallelepipedal shape of the energy-absorbing device.

The energy-absorbing device 101 comprises at least a core 113 made of at least one energy-absorbing material, and at least one plastic structure 133 forming a one-piece entity with the core 113. The core 113 and the plastic structure 133 will each partly define the faces 103, 105, 107, 109, 111 of the energy-absorbing device 101, and more particularly the external face 103 and the internal face 105.

The core 113 is intended to absorb the energy and the plastic structure 133 serves both to support and to reinforce the core 113. However, it should also be noted that the plastic structure 133 is able to contribute to all of the properties of the energy-absorbing device 101, as will be explained in greater detail hereinafter.

The energy-absorbing material of the core 113 is different than the plastic structure 133. The energy-absorbing material may notably consist of a mixture of continuous fibers, including glass fibers, carbon fibers or any synthetic or natural fibers, and thermoplastic or thermosetting resins.

The shape of the core 113, in addition to the material of which it is made, contributes to the energy-absorbing properties of said core. The core 113 is thus special in that it has a corrugated shape 115 the details of which are notably visible in FIG. 2. The corrugated shape 115 is a succession of at least one peak 117 and at least one trough 117 which are also referred to as crests. For the remainder of the description, the reference 117 will be used indiscriminately to denote a crest, a peak and a trough.

In the first embodiment particularly illustrated in FIG. 1 and in FIG. 2, the corrugated shape 115 comprises a plurality of crests 117 which succeed one another in a direction of extension E advantageously parallel to the main direction of elongation A of the energy-absorbing device 101. The corrugated shape 115 of the core 113 extends over the entire length U of the energy-absorbing device 101 to ensure continuous absorption of energy over substantially the entire transverse length W of the vehicle 1.

The crests 117 of the corrugated shape 115 are oriented such that some of them define the external face 103 of the energy-absorbing device 101. The crests 117 thus all fall within the plane in which the external face 103 extends. More particularly in FIG. 2, the majority of the crests 117 define the external face 103. As a result, some of the crests 117 are arranged in such a way as to receive the energy resulting from one or more impact.

In the first embodiment illustrated in FIG. 1 and in FIG. 2, the upper face 107 and the lower face 109 of the energy-absorbing device 101 are formed at least in part by at least one segment of the corrugated shape of the core 113, the segments of the corrugated shape corresponding to a section of this corrugated shape in a transverse and vertical plane of section and forming a sinusoid inside which the successive crests fall. Advantageously, the longitudinal end edges of the corrugated shape, which form sharp cutting edges, are thus oriented to at least partially form the upper face and/or the lower face, namely faces that do not directly face the element that is to be protected from the impact or that do not directly face the external element that the vehicle strikes.

The energy-absorbing properties of the energy-absorbing device 101 are thus dependent, in addition to being dependent upon the materials used, on characteristics of the corrugated shape 115, which characteristics include an amplitude AMPc of the crests 117, a radius of curvature Rc of the crests 117, a pitch PASc of the crests and the thickness EPAc of the corrugated shape 115.

These characteristics may vary from one transverse end to the other, and in this context, the energy-absorbing device as illustrated in FIG. 2 may exhibit a longitudinal and vertical plane of symmetry 300.

The amplitude AMPc is defined as being a distance between the projection of two successive crests 117 onto a direction perpendicular to the direction of extension E of the succession of crests 117 and contained in a plane parallel to a plane in which the upper face 107 extends.

As is visible in FIG. 2, the amplitude AMPc of the crests 117 has a value that is substantially constant in the direction of extension E. It may also be seen that the amplitude AMPc is substantially equal to the width Pd of the energy-absorbing device 101, the crests lying flush alternately with the external face 103 and with the internal face 105.

The radius of curvature Rc of a crest 117 corresponds to the radius of a circle inside which the crest 117 can be inscribed, the circle being viewed in a plane containing the direction of extension E of the succession of crests 117 and being parallel to the plane in which the upper face 107 extends. The crests 107 may have radii of curvature which change from one transverse end of the energy-absorbing device 101 to the other, and thus have shapes the roundedness of which varies according to their location within the energy-absorbing device 101.

In the example more particularly illustrated in FIG. 2, the crests of a first part 119 of the corrugated shape 115 have a first radius of curvature Rc of value R1, and the crests 117 of the second part 121 of the corrugated shape 115 have a second radius of curvature Rc of value R2. In this example, the first part 119 is a central part surrounded on each side transversely by two second parts 121, and the first radius of curvature Rc, R1 is greater than the second radius of curvature Rc, R2. As a result, the crests 117 arranged at the center of the energy-absorbing device 101 have a shape that is more rounded than that of the crests 117 arranged transversely to the sides in the second part 121.

The corrugated shape 115 illustrated in FIG. 1 or in FIG. 2 may comprise at least one other part in which the crests 117 have a radius of curvature Rc different than the first radius of curvature Rc, R1 and different than the second radius of curvature Rc, R2.

More particularly, the radius of curvature Rc of the crests 117 of the corrugated shape 115 may vary uniformly in the direction of extension E, with a radius of curvature Rc of the crests 117 that exhibits a maximum value at the center of the device and decreases in both senses of the direction of extension E toward the transverse ends of the device.

The pitch PASc is defined as being the distance between two peaks 117 of the corrugated shape 115 which succeed one another and lie flush with the one same face defining the energy-absorbing device, the external face 105 in the example illustrated in FIG. 2. The pitch is measured in the direction of extension E of the succession of crests 117. In other words, the pitch PASc is the transverse distance, which is to say the distance in the direction of extension E of the succession of crests 115, between two successive pattern units, each pattern unit comprising two adjacent crests 117, which is to say a peak and a trough.

As is more particularly visible in FIG. 2, the pitch PASc varies in the direction of extension E of the succession of crests 115. More specifically, the crests 117 of a first part 119 of the corrugated shape 115 have a first pitch PASc, PAS1, and the crests 117 of a second part 121 of the corrugated shape 115 have a second pitch PASc, PAS2. The first pitch PASc, PAS1 is greater than the second pitch PASc, PAS2. As a result, the crests 117 of the first part 119, in this instance the central portion of the device, are less closely spaced from one another than in the second part 121, in this instance the lateral portions positioned transversely on each side of the central portion.

The thickness EPAc of the corrugated shape 115 may be defined as being the distance between two ends of the corrugated shape 115, measured along an axis perpendicular to the direction of extension E and contained in a plane parallel to the main plane of elongation 200 of the internal face 105. More particularly, in the case illustrated here where the crests 117 contribute to delimiting the external face 103, the thickness is the distance between two opposite segments of the corrugated shape that respectively form the end edges of the corrugated shape. In FIG. 1 and in FIG. 2, the thickness EPAc of the corrugated shape 115 remains substantially constant along the direction of extension E. In this particular instance, the thickness EPAc of the corrugated shape 115 corresponds to the height H of the energy-absorbing device 101.

The configurations may thus differ in terms of the value of the pitch, the value of the amplitude and/or the value of the radius of curvature. It will therefore be appreciated that it is possible to vary one or more characteristics of the corrugated shape such that the energy-absorbing device exhibits the desired technical and esthetic properties.

As has been mentioned, the energy-absorbing device according to the invention is such that the core and the plastic structure form a one-piece entity. More particularly, the core 113 of the energy-absorbing device 101 is set inside the mass consisting of the plastic structure 133. The plastic structure 133 may for example be overmolded on the core 113.

The plastic structure 133 comprises a plurality of walls including external walls which delimit a peripheral shell inside which the core 113 is inscribed, and internal walls 135 which extend across the plastic structure, connecting the external walls to one another.

The internal walls 135 have longitudinal end edges which, at a first longitudinal end of the device, at least partly define the external face 103, complementing the at least some of the crests 117 of the corrugated shape 115 of the core. Additionally, the longitudinal end edges of the internal walls, at a second longitudinal end of the device, may at least partly define the internal face 105, complementing the at least some of the crests 117 of the corrugated shape 115 of the core.

The internal walls 135 are arranged in such a way that the longitudinal end edges present in the vicinity of the external face 103 and of the internal face 105, respectively, together form a pattern 137 viewed in the main plane of extension of the external face 103, and of the internal face 105, respectively, of the energy-absorbing device.

As illustrated, the pattern 137 formed by the longitudinal end edges of the internal walls 135 of the plastic structure 133 in the vicinity of one of the, external or internal, faces of the energy-absorbing device 101 is a set of lines that intersect one another, extending from one external wall of the peripheral shell of the plastic structure to the other, when viewed in the main plane of extension of the external face 103.

In the first embodiment illustrated in FIGS. 1 to 3, the pattern 137 formed by the plastic structure 133 on the external face 103 comprises a plurality of lozenge shapes of different dimensions, these dimensions varying in the main direction of elongation A of the energy-absorbing device 101. In an embodiment which has not been depicted, the pattern formed by the plastic structure on the external face of the energy-absorbing device is a grid.

It is possible to vary the pattern 137 by modifying the arrangement of the walls and notably of the internal walls 135 of the plastic structure 133. In a first variant of the first embodiment, the internal walls 135 are arranged in such a way that the pattern 137 exhibits a honeycomb structure as visible in FIG. 4.

In a second variant of the first embodiment, the internal walls 135 of the plastic structure 133 are arranged in such a way that the pattern 137 has the form of rectangles arranged in a staggered configuration, as visible in FIG. 5.

In each of these variants, it should be noted that the intrinsic thickness of the internal walls has been depicted as constant from one internal wall to another, with the intrinsic thickness to be understood here as being the smallest dimension of the sheet that forms the corresponding internal wall, independently of the notion of thickness EPAc of the corrugated shape, which for its part is measured in the vertical direction. Further, the intrinsic thickness of the internal walls is the same from one variant to another. Alternatively, although this has not been depicted, provision may be made for the intrinsic thickness of at least one internal wall to be modified, for example increased, in order to improve the force-absorbing properties of the device according to the invention. Further, provision may also be made for the internal walls arranged in a first part of the plastic structure to have an intrinsic thickness different than the intrinsic thickness of the internal walls arranged in a second part of the plastic structure, within the one same device, so as to alter the absorption properties according to the exposure of the corresponding zone of the device according to the invention.

Although, in FIGS. 1 to 5, the pattern is arranged only on the external face 103, it is entirely possible for it to be arranged also, or alternatively, on one or more other faces of the energy-absorbing device 101. In general, this feature of the plastic structure therefore makes it possible to modify the energy-absorbing properties of the energy-absorbing device 101.

The plastic structure 135 also offers the advantage of being formed integrally with the attachment means 153. Thus, the attachment means 153 are also created at the same time as the plastic structure 133 is being overmolded on the core 113. This also makes it possible to simplify the mounting of the device according to the invention on the body 3 of the vehicle 1.

It is also possible for the vehicle 1 to be equipped with a plurality of energy-absorbing devices according to the invention. These energy-absorbing devices may be arranged together on a vehicle element that is to be protected. This notably allows the energy-absorbing devices to be positioned only at points of great mechanical weakness of the element that is to be protected. Further, it makes it possible to facilitate integration of these devices on the element that is to be protected.

This possibility is depicted in FIG. 6 by a vehicle 1 comprising two energy-absorbing devices 201 according to a second embodiment of the invention and one energy-absorbing device 301 according to a third embodiment of the invention. The energy-absorbing devices 201, 301 are intended to form part of a rear bumper. However, they could equally well be positioned on another element of the vehicle 1, such as an electric battery, in order to protect same.

The energy-absorbing devices 201, 301 are positioned on a rear part of the body 3 of the vehicle 1. With reference to FIG. 6, the energy-absorbing devices 201, 301 each have a length U less than the transverse length W of the vehicle 1 in the transverse direction as previously mentioned. Further, the main directions of elongation A of the energy-absorbing devices 201, 301 are mutually parallel. As a preference, the main directions of elongation A of the energy-absorbing devices 201, 301 are coincident.

The second embodiment of the energy-absorbing device according to the invention, illustrated in greater detail in FIG. 7, differs from the first embodiment notably in that the amplitude AMPc of the corrugated shape 115 of the core 113 varies in the direction of extension E of the succession of crests 117 of the corrugated shape 115. Elements that are identical to the first embodiment are denoted by the same references. For further details regarding these identical elements, reference may be made to the foregoing description.

With reference to FIG. 7, the internal face 105 of the energy-absorbing device 201 extends in the main plane of elongation 200 whereas the external face 103 extends in a plurality of planes at least one of which is parallel to the main plane of elongation 200.

More particularly, a first portion of the external face 103 extends in a first plane, a second portion of the external face 103, which forms a central portion of this external face, extends in a second plane which is parallel to the main plane of elongation 200, and a third portion extends in a third plane. The first plane and the second plane are secant and not coincident with one another and are secant and not coincident with the main plane of elongation 200.

As a result, the width Pd of the energy-absorbing device 201 varies in the main direction of elongation A, namely in the direction of extension E of the succession of crests 117 of the corrugated shape 115 of the core 113 that forms the energy-absorbing device 201. Thus, the energy-absorbing device 201 has a first portion in which the width Pd has a first value P1 and a second portion in which the width Pd has a second value P2. In the exemplary embodiment depicted in FIG. 7, the width Pd, P1 of the first portion of the device 201 is smaller than the width Pd, P2 of the second portion of the device 201.

The height H of the energy-absorbing device 201, as defined hereinabove, is constant in the direction of elongation A of the energy-absorbing device 201.

According to the embodiments previously described, the crests 117 of the core 113 illustrated in FIG. 7 are oriented such that some of them define the external face 103 of the energy-absorbing device 201. Furthermore, another proportion of the crests 117 of the corrugated shape 115 defines the internal face 105 of the energy-absorbing device 201.

It will be appreciated in this context that the amplitude AMPc of the corrugated shape 115 as defined hereinabove varies in the main direction of elongation A of the energy-absorbing device 201, namely in the direction of extension E. More particularly, the corrugated shape 115 has a first part 119 in which the amplitude AMPc has a first value AMP1 and a second part 121 in which the width AMPc has a second value AMP2. In the exemplary embodiment depicted in FIG. 7, the width amplitude AMPc, AMP1 of the first part 119 of the corrugated shape 115 is smaller than the amplitude AMPc, AMP2 of the second part 121 of the corrugated shape 115.

It should be noted that, in this second embodiment, the first portion of the device 201 corresponds to the first part 119 of the corrugated shape 115, and that the second portion of the device 201 corresponds to the second part 121 of the corrugated shape 115. As a result, the amplitude AMPc of the corrugated shape 115 corresponds to the width Pd of the energy-absorbing device 201.

In this second embodiment, the variation in width of the energy-absorbing device from one longitudinal end to the other is thus achieved by varying the amplitude of the corrugated shape.

With reference to FIG. 7, the crests 117 of the corrugated shape 115 of the core 113 have a radius of curvature Rc that is substantially constant in the direction of extension E.

In a similar way to the embodiment illustrated in FIGS. 1 to 5, in the energy-absorbing device 201 according to the second embodiment, the thickness EPAc of the corrugated shape 115 is substantially constant in the direction of extension E and corresponds to the height H of the energy-absorbing device 201, and the pitch PASc of the corrugated shape 115 varies in the direction of extension E and therefore in the main direction of elongation A. Further, the energy-absorbing device 201 has a longitudinal and vertical plane of symmetry 300.

The third embodiment of the energy-absorbing device according to the invention and illustrated in FIG. 8 differs from the second embodiment notably in that the external face 103 of the energy-absorbing device 301 is formed at least in part by a segment of the corrugated shape 115 of the core 113 rather than of the crests 117 as described in the second embodiment.

As it has been possible to describe previously, a segment of the corrugated shape 115 corresponds to a section of this corrugated shape in a transverse and vertical plane of section. As a result, straight edges contribute to defining the external face 103, and some of the crests 117 at least partially define the upper face 107 of the energy-absorbing device 301, in a plane substantially perpendicular to the main plane of elongation 200.

Elements that are identical to the first embodiment and to the second embodiment are denoted by the same references. For further details regarding these identical elements, reference may be made to the foregoing description. It should, however, be noted that the energy-absorbing device according to this third embodiment, with an external face defined at least partly by a segment of the corrugated shape of the core, which is described here only in the context of an application with a plurality of energy-absorbing devices, could be implemented on its own.

In a similar way to the second embodiment, in this third embodiment depicted in FIG. 8, the width Pd of the energy-absorbing device 201 varies in the main direction of elongation A, namely in the direction of extension E of the succession of crests 117 of the corrugated shape 115 of the core 113 that forms the energy-absorbing device 301.

With reference to FIG. 8, the pitch PASc of the corrugated shape 115 is substantially constant in the direction of extension E. The amplitude AMPc of the corrugated shape 115 is also substantially constant. The amplitude AMPc of the corrugated shape 115 corresponds to the height H of the energy-absorbing device 301.

The radius of curvature Rc of the crests 117 of the corrugated shape 115 is substantially constant in the direction of extension E of the corrugated shape 115. The radius of curvature Rc of the crests 117 corresponds here to the radius of a circle inside which the crest 117 can be inscribed, the circle being viewed in a plane containing the direction of extension E of the succession of crests 117 and being parallel to a main plane of elongation 200 of the internal face 105.

The thickness EPAc of the corrugated shape 115 varies in the direction of extension E. It is defined here as being the distance between two ends of the corrugated shape 115, measured along an axis perpendicular to the direction of extension E and contained in a plane perpendicular to the main plane of elongation 200 of the internal face 105.

It will be appreciated that, because of the shape of the energy-absorbing device 301 and because of the arrangement of the corrugated shape 115 of the core 113 within the energy-absorbing device 301, the thickness EPAc of the corrugated shape 115 corresponds to the width Pd of the energy-absorbing device 301.

In this third embodiment, the variation in width of the energy-absorbing device from one longitudinal end to the other is thus achieved by varying the thickness of the corrugated shape.

In the second embodiment and in the third embodiment, the attachment means 153 formed integrally with the plastic structure 133 are barrels, not visible, integrated in a volume defined by faces of the plastic structure 133.

FIG. 9 is a set of FIGS. 9a and 9b illustrating test results for two different energy-absorbing devices.

The curve numbered “1” corresponds to an absorbing device according to the invention, of which the external face 103 is formed at least partly by crests 117 of the corrugated shape 115 of the core 113 (hereinafter referred to as device 1). The curve numbered “2” corresponds to an absorbing device of which the external face 103 is formed at least partly by at least one segment of the corrugated shape 115 of the core 113 (hereinafter referred to as device 2).

As illustrated in FIG. 9a, device 1 according to the invention is able to absorb more energy than device 2 when the frontal face of each device is displaced by the same distance in an impact.

FIG. 9b shows the reaction force measured at an impact tool used for the test as this tool collides with the energy-absorbing device. As illustrated by FIG. 9b, at the start of the collision, a reaction-force spike of around 10500 N is measured at the impact tool when the frontal face of device 2 is displaced by around 10 mm. By contrast, the reaction force measured for device 1 increases constantly during crumpling, said reaction force always remaining below the peak value measured in the case of the first device 1.

The invention as has just been described is able to achieve its stated objectives, notably insofar as it is able to offer an energy-absorbing device, notably one that can be used to form a motor vehicle bumper, that is able to offer, between the zones of attachment to the element that is to be protected from impact, an energy-absorption zone of which the pattern units can easily be modified in order to suit the energy-absorption requirements of the vehicle, for example, and which is able to distribute the forces towards these attachment zones for transmission to the body structure.

Of course, the invention is not limited to the examples that have just been described, and numerous modifications may be made to these examples without departing from the scope of the invention.

1. An energy-absorbing device for a vehicle, the energy-absorbing device comprising:
a main direction of elongation,
an external face intended to receive at least one impact,
a core made of at least one energy-absorbing material,
wherein the core is of a corrugated shape with a succession of crests in a direction of extension parallel to the main direction of elongation, and
at least one plastic structure forming a one-piece entity with the core,
wherein the at least one plastic structure comprises means of attaching the energy-absorbing device to an element of the vehicle which is to be protected,
wherein the external face is formed at least in part by the crests of the corrugated shape of the core.

2. The energy-absorbing device as claimed in claim 1,
wherein the succession of crests extends over the entire length of the energy-absorbing device in the main direction of elongation.

3. (canceled)

4. The energy-absorbing device as claimed in claim 1,
wherein the corrugated shape has an amplitude that varies in the direction of extension of the succession of crests.

5. The energy-absorbing device as claimed in claim 1,
wherein the corrugated shape has a pitch that varies in the direction of extension of the succession of crests.

6. The energy-absorbing device as claimed in claim 1,
wherein the corrugated shape has a variable shape varying along the direction of elongation of the energy-absorbing device,
wherein the corrugated shape comprises a first part and a second part,
wherein the first part of the corrugated shape has a configuration different than a configuration of the second part of the corrugated shape.

7. The energy-absorbing device as claimed in claim 1,
wherein the attachment means are formed integrally with the plastic structure.

8. The energy-absorbing device as claimed in claim 1,
wherein the energy-absorbing material is a glass fiber reinforced plastic.

9. A vehicle comprising at least one element to be protected from impact and at least one energy-absorbing device as claimed in claim 1,
wherein the energy-absorbing device being is attached to the element that is to be protected using the attachment means such that the external face is on the opposite side from the element that is to be protected, and an internal face of the energy-absorbing device, opposite to the external face, faces the element that is to be protected.
